(19) United States
(12) Patent Application Publication
(10) Pub. No.: US 2006/0255032 A1
(43) Pub. Date: Nov. 16, 2006

(54) Sound-outputting container-closure article and method

(76) Inventor: Randolph Borene, El Dorado Hills, CA (US)

Correspondence Address: FULWIDER PATTON LLP;Howard Hughes Center, Tenth Floor, 6060 Center Drive, Los Angeles, CA, 90045-1597, US

(21) Appl. No.: 11/400,060

(22) Filed: Apr. 7, 2006

Related U.S. Application Data
(60) Provisional application No. 60/669,845, filed on Apr. 8, 2005.

(51) Int. Cl. B65D 51/00; G08B 3/10; B65D 73/00; G08B 25/08

(52) U.S. Cl. 220/200; 206/457; 340/692; 340/384.7

(57) ABSTRACT

A closure for enabling the covering of a container, and for enabling the removal thereof so as to output sound. The sound outputted by the closure may comprise the sound of a popping cork, and the container may comprise a wine bottle. The outputted sound may comprise a user-recordable output such as a user message. The closure enables substantial airtight covering of the container, and is comprised of a material which is substantially inert, to resist spoilage and maintain flavor consistency of the contents of the container.

### CROSS-REFERENCE TO RELATED APPLICATION

This application is claiming the benefit of a co-pending provisional application Ser. No. 60/669,845 filed on Apr. 8, 2005.

### BACKGROUND OF THE INVENTION

1. Field of the Invention

This invention relates generally to container closures, and more particularly to a container closure which outputs sound upon removal of the closure from covering a container.

2. General Background and State of the Art

A closure such as a cork has been used in conjunction with a container such as a wine bottle to provide the benefit of an inert means for sealing the wine bottle. Natural cork has long been used for its original preferability, as well as its traditional appeal. However, wine spoilage as a result of tainting has been attributed to natural cork closures. Screw top caps and synthetic stoppers have been introduced to utilize their inert qualities in interfacing with aging beverages such as wine.

One of the appealing features of a natural cork stopper is the sound it makes as it is removed from an unopened bottle of wine. Another appealing feature of a natural cork stopper is the relative ease of removal, due to its inherent physical properties, when compared with the removal of similar stoppers made from synthetic material.

It would therefore be desirable to provide a closure that emits a sound, such as a cork popping or a user-recordable output such as a user message, upon being removed from a container. It would further be desirable to provide such a closure that is substantially inert and airtight, to resist spoilage and maintain flavor consistency of the contents of the container.

### INVENTION SUMMARY

Briefly and in general terms, the present invention, in a preferred embodiment by way of example, is directed to a closure for enabling placement thereof on a container so as to cover the container, and enabling removal from the container and outputting of sound upon removal thereof from the container. The closure includes a housing which is able to be placed on the container so as to cover the container, and to be removed from the container. It further includes a sound outputting circuit, for enabling outputting of sound upon removal of the closure from the container.

The closure also includes a switch, operably connectable with the sound outputting circuit, which is able to enable the sound outputting circuit to be open upon placing the closure on the container, and to enable the sound outputting circuit to be closed upon removal of the closure from the container so as to activate the sound outputting circuit and output the sound thereupon. Further, it includes a switch activating mechanism, for enabling the switch to be open, upon placing the closure on the container, and for enabling the switch to be closed, upon removal of the closure from the container, to enable the sound outputting circuit to output the sound thereupon.

In other aspects of the invention, the closure includes a material which is substantially inert relative to contents of the container, and the material of which the closure is comprised enables substantially airtight sealing of the container upon placement of the closure on the container. The closure may include a user-recordable output, for enabling the outputting of a user-recordable sound such as a user message therefrom.

These and other aspects and advantages of the invention will become apparent from the following detailed description and the accompanying drawings, which illustrate by way of example the features of the invention.

### BRIEF DESCRIPTION OF THE DRAWINGS

FIG. 1 is an elevational partly sectional view of a container closure.

FIG. 2 is a circuit diagram of a sound outputting circuit in a container closure.

### DETAILED DESCRIPTION OF THE PREFERRED EMBODIMENTS

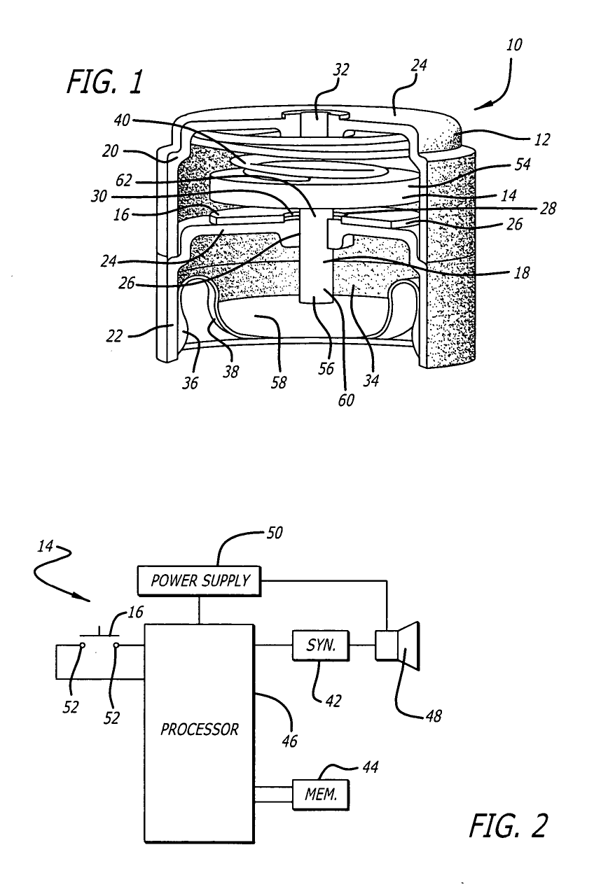

The closure of this invention, as described herein and illustrated in FIGS. 1-2, enables the covering of the contents of a container, and enables the removal thereof from the container to output a sound thereupon. The closure may comprise a stopper, the container may comprise a wine bottle or other type of bottle, or a jar, carton, or can, and the outputted sound upon removal of the stopper from the wine bottle may comprise the sound of a cork popping out of a wine bottle or a user-recordable output such as a user message. The contents of the container may comprise, for example, wine, a carbonated beverage, or perfume. The closure includes a material which is substantially inert relative to the contents of the container, which interacts with the contents of the container such as wine to prevent spoilage and maintain flavor consistency, and which enables substantially airtight sealing of the container upon placement of the closure on the container.

The closure 10, as shown in FIGS. 1-2, includes a housing 12, able to be placed on a container so as to cover the container, and able to be removed from the container, and a sound outputting circuit 14, able to output sound upon removal of the closure 10 from the container. The closure 10 further includes a switch 16, operably connectable with the sound outputting circuit 14, for enabling the sound outputting circuit 14 to be open upon placing the closure 10 on the container, and for enabling the sound outputting circuit 14 to be closed upon removal of the closure 10 from the container so as to activate the sound outputting circuit 14 and output the sound thereupon. It also includes a switch activating mechanism 18, able to enable the switch 16 to be open upon placing the closure 10 on the container, and to enable the switch 16 to be closed upon removal of the closure 10 from the container so as to enable the sound outputting circuit 14 to output the sound thereupon.

The housing 12 may be hermetically or ultrasonically sealed for protection. It includes an upper section 20 and a lower section 22. The housing upper section 20 comprises an upper shell, and the housing lower section 22 comprises a lower shell. The upper shell 20 and the lower shell 22 are secured together. The housing lower shell 22 includes an upper portion 24, which has a central opening 26, the switch 16 includes a switchplate 28, which has a central opening 30, and the switchplate 28 is secured to the lower shell upper portion 24. The housing upper shell upper portion 24 has a central opening 32 through which sound from the sound outputting circuit 14 is able to be outputted. The housing lower section 22 includes a diaphragm 34, able to cover the container upon placing the closure 10 on the container. The housing upper section 20 and the lower section 22, and the diaphragm 34 and the lower section 22, are secured together, as by an adhesive.

The diaphragm 34 constitutes a thin supple sheath, and is comprised of a material such as a synthetic elastomer which has chemically resistive qualities, and which is substantially inert relative to the contents of the container such as wine in a wine bottle. The material of which the diaphragm 34 is comprised is also able to seal the container in a substantially airtight manner. Different membrane materials may be used for the diaphragm 34 for different wines or other materials or liquids, and the characteristics of the material of the diaphragm 34 may enable the inclusion of various additives in contents of the container 10 such as carbonated beverages. The diaphragm 34 includes a thickened section 36, and a plunger area 38. The diaphragm thickened portion 36 is able to engage the container, to maintain engagement therewith, and to enable release therefrom upon exertion of releasing pressure on the closure 10. The switch activating mechanism 18 includes a coil spring 40, and the diaphragm thickened portion 36 is able to engage the container, with the friction generated thereby able to counter pressure applied by the coil spring 40.

The sound outputting circuit 14, as seen in FIG. 2, includes a sound synthesizer 42, able to output sound signals, a memory 44, operably connected to the sound synthesizer 42, which contains sound data, and a processor 46, operably connected to the sound synthesizer 42 and the memory 44, configured to control the sound synthesizer 42 in the generation of the sound data from the sound data selected from the memory 44. It may include a memory chip for enabling the recording of a user-recordable output such as a user message. It further includes a speaker 48, operably connected to the sound synthesizer 42 to reproduce sounds based upon the sound signals outputted by the sound synthesizer 42.

The sound outputting circuit 14 also includes a power supply 50, which may comprise a battery, for supplying power to the sound outputting circuit 14, and switch connections 52, which are normally in an open sound outputting circuit mode, and which are able to be contacted by the switch 16 to generate a closed sound outputting circuit mode. Alternatively, the closure 10 may include a slot for enabling insertion and removal of the power supply battery, enabling the use of a replaceable power supply. The sound outputting circuit 14 is enclosed in a casing 54, which is generally disk-shaped, as illustrated in FIG. 1. The sound outputted by the sound outputting circuit 14 may comprise a cork popping upon being removed from a wine bottle, another pre-recorded sound such as an advertising or promotional message, nutritional information, or a user-recordable output, which may comprise a user message. The sound may be recorded on a chip, which may enable recording for example for time periods from one second to one minute.

The switch 16 includes the switchplate 26, and further includes the switch connections 52 in the sound outputting circuit 14, which are able to interact with the switchplate 26. The switchplate 26 is generally disk-shaped, and is comprised of an electrically-conductive material. The switch activating mechanism 18 includes the coil spring 32, and a plunger 56. The flexibility of the diaphragm 34 enables the plunger 56 to rise and fall. The plunger 56 includes a disk portion 58 and a shaft portion 60 extending from the disk portion 58. The plunger shaft portion 60 extends through the lower section upper portion central opening 28 and the switchplate central opening 30, and includes an upper end 62 secured to the sound outputting circuit casing 54. Alternatively, nanotechnology components may be incorporated in release activation devices and motors in the switch activating mechanism 18.

Upon placement of the closure 10 onto a container, the internal perimeter of the diaphragm 34 forms a substantially airtight seal, with the thickened portion 36 engaging the exterior surface of the container, and with pressure exerted by the container up through the plunger area 38, overcoming resistance from the coil spring 40. Upon removal of the closure 10 from the container, pressure from the plunger area 38 is removed, and the coil spring 40, which is positioned between the upper shell upper portion 24 and the sound outputting circuit casing 54, exerts pressure on the sound outputting circuit casing 54 to bear against the switchplate 26, which contacts the switch connections 52, to close the sound outputting circuit 14 and to output the sound through the central opening 32. The coil spring 40 is further able to apply pressure on the plunger disk portion 58, through contact with the sound outputting circuit casing 54 and through the plunger shaft portion 60.

While the particular closure as shown and disclosed in detail herein is fully capable of obtaining the objects and providing the advantages previously stated, it is to be understood that it is merely illustrative of the presently preferred embodiment of the invention, and that no limitations are intended to the details of construction or design shown herein other than as described in the appended claims.

I claim:

1. A closure for enabling the covering of a container, and for enabling the removal thereof from the container so as to output sound thereupon, comprising:
a housing, for enabling the covering of the container, and removal thereof from the container;
a sound outputting circuit, for enabling sound to be outputted upon removal of the closure from the container;
a switch, operably connectable with the sound outputting circuit, for enabling the sound outputting circuit to be open upon placing the closure on the container, and for enabling the sound outputting circuit to be closed upon removal of the closure from the container, so as to activate the sound outputting circuit and output the sound thereupon; and
a switch activating mechanism, for enabling the switch to be open upon placing the closure on the container, and for enabling the switch to be closed upon removal of the closure from the container so as to enable the sound outputting circuit to output the sound thereupon.

2. A closure as in claim 1, wherein the sound which is able to be outputted by the closure comprises the sound of a cork popping out of a wine bottle.

3. A closure as in claim 1, wherein the closure includes a material which is substantially inert relative to contents of the container.

4. A closure as in claim 1, wherein the closure includes a material for enabling the substantially airtight sealing of the container upon placement of the closure on the container.

5. A closure as in claim 1, wherein the housing comprises a stopper and the container comprises a wine bottle.

6. A closure as in claim 1, wherein the housing includes an upper section and a lower section.

7. A closure as in claim 1, wherein the sound outputting circuit includes a sound synthesizer, for enabling the outputting of sound signals, a memory, operably connected to the sound synthesizer, which contains sound data, a processor, operably connected to the sound synthesizer and the memory, configured to control the sound synthesizer in the generation of the sound data from the sound data selected from the memory, a speaker, operably connected to the sound synthesizer to reproduce sounds based upon the sound signals outputted by the sound synthesizer, a power supply, for supplying power to the sound outputting circuit, and switch connections, which are normally in an open sound outputting circuit mode, and which are able to be contacted by the switch to generate a closed sound outputting circuit mode.

8. A closure as in claim 1, wherein the sound outputting circuit further includes a user-recordable output, for enabling a user-recordable sound to be input therein and output therefrom.

9. A closure as in claim 1, wherein the switch includes a switchplate.

10. A closure as in claim 1, wherein the switch activating mechanism includes a plunger, which includes a disk portion and a shaft portion extending from the disk portion.

11. A closure as in claim 6, wherein the housing upper section comprises an upper shell, and the housing lower section comprises a lower shell.

12. A closure as in claim 6, wherein the housing lower section includes a diaphragm for covering the container.

13. A closure as in claim 9, wherein the sound outputting circuit includes switch connections, and the switch further includes the switch connections in the sound outputting circuit, able to interact with the switchplate.

14. A closure as in claim 9, wherein the switchplate is comprised of an electrically-conductive material.

15. A closure as in claim 9, wherein the switchplate is generally disk-shaped.

16. A closure as in claim 10, wherein the switch activating mechanism further includes a coil spring.

17. A closure as in claim 11, further including a casing in which the sound outputting circuit is enclosed, and wherein the housing lower section comprises a lower shell which includes an upper portion having a central hole therein, the switchplate has a central hole through which the plunger shaft portion extends, and is positioned on top of the lower shell upper portion, the plunger shaft portion extends through the lower shell upper portion central hole, and the plunger shaft portion includes an upper end secured to the sound outputting circuit casing.

18. A closure as in claim 11, further including a casing in which the sound outputting circuit is enclosed, the housing upper section comprises an upper shell which includes an upper portion therein, the switch includes a switchplate, and the switch activating mechanism includes a coil spring, which is positionable between the upper shell upper portion and the sound outputting circuit casing, and is able to exert pressure on the switchplate.

19. A closure as in claim 11, wherein the lower shell includes an upper portion, the switch includes a switchplate, and the switchplate is secured to the lower shell upper portion.

20. A closure as in claim 11, wherein the upper shell includes an upper portion having a central opening through which sound is able to outputted from the sound outputting circuit.

21. A closure as in claim 11, wherein the upper shell and the lower shell are secured together.

22. A closure as in claim 12, wherein the diaphragm includes a thickened section, and a plunger area.

23. A closure as in claim 12, wherein the diaphragm is able to cover the container upon placing the closure on the container.

24. A closure as in claim 12, wherein the diaphragm is comprised of a material which is substantially inert relative to contents of the container.

25. A closure as in claim 12, wherein the diaphragm is able to form a substantially airtight seal with the container upon placement of the closure on the container.

26. A closure as in claim 17, wherein the switch activating mechanism includes a coil spring, and the coil spring is able to apply pressure on the plunger disk portion through contact with the sound outputting circuit casing and the plunger shaft portion.

27. A closure as in claim 17, wherein the casing in which the sound outputting circuit is enclosed is generally disk-shaped.

28. A closure as in claim 22, wherein the diaphragm thickened portion is able to engage the container, to maintain engagement therewith, and to enable release therefrom upon the exertion of releasing pressure on the closure.

29. A closure as in claim 22, wherein the switch activating mechanism includes a coil spring, and the diaphragm thickened portion is able to engage the container and to counter pressure applied by the coil spring.

30. method of enabling a closure to cover a container, and for enabling the removal of the closure from the container so as to output sound thereupon, in a system which comprises a housing, for enabling the covering of the container, and removal thereof from the container, a sound outputting circuit, for enabling sound to be outputted upon removal of the closure from the container, a switch, operably connectable with the sound outputting circuit, for enabling the sound outputting circuit to be open upon placing the closure on the container, and for enabling the sound outputting circuit to be closed upon removal of the closure from the container, so as to activate the sound outputting circuit and output the sound thereupon, and a switch activating mechanism, for enabling the switch to be open upon placing the closure on the container, and for enabling the switch to be closed upon removal of the closure from the container so as to enable the sound outputting circuit to output the sound thereupon, wherein the method comprises:
placing the closure on the container so as to cover the container; and
removing the closure from the container so as to operate the switch activating mechanism, to operate the switch, close the sound outputting circuit, and output sound thereupon.

31. A method as in claim 30, wherein the sound which is able to be outputted by the closure comprises the sound of a cork popping out of a wine bottle, and wherein removing the closure from the container in the method further comprises outputting the sound of a cork popping out of a wine bottle.

32. A method as in claim 30, wherein the closure includes a material for enabling the substantially airtight sealing of the container upon placement of the closure on the container, and wherein placing the closure on the container in the method further comprises enabling substantially airtight sealing of the container thereupon.

33. A method as in claim 30, wherein the closure includes a material which is substantially inert relative to contents of the container, and wherein placing the closure on the container in the method further comprises enabling substantially inert covering of the container.

34. A method as in claim 30, wherein the sound outputting circuit further includes a user-recordable output, for enabling a user-recordable sound to be input therein and output therefrom, and wherein removing the closure from the container in the method further comprises enabling the user-recordable sound to be input output therefrom.
